(19) United States
(12) Patent Application Publication
(10) Pub. No.: US 2016/0371196 A1
(43) Pub. Date: Dec. 22, 2016

(54) MEMORY MANAGEMENT UNIT AND OPERATING METHOD THEREOF

(71) Applicant: ELECTRONICS AND TELECOMMUNICATIONS RESEARCH INSTITUTE, Daejeon (KR)

(72) Inventor: Kwang Won KOH, Daejeon (KR)

(21) Appl. No.: 15/178,184

(22) Filed: Jun. 9, 2016

(30) Foreign Application Priority Data
Jun. 16, 2015 (KR) 10-2015-0085267

(51) Int. Cl. G06F 12/10

(52) U.S. Cl. CPC G06F 12/1009; G06F 12/1027; G06F 2212/1016; G06F 2212/152; G06F 2212/651; G06F 2212/682; G06F 2212/683

(57) ABSTRACT

A memory management unit MMU for managing virtual memory for a plurality of cores includes a plurality of translation lookaside buffers TLBs each corresponding to each of the cores; a plurality of page tables each corresponding to each of the cores and to each of the TLBs, and each synchronized with a corresponding TLB, a meta page including virtual page-physical page mapping information included in the plurality of page tables, one of the plurality of page tables being a main page table; and the meta page including a shared bit field indicating whether or not the virtual page-physical page mapping information is stored in the plurality of TLBs.

### CROSS-REFERENCE TO RELATED APPLICATION

The present application claims priority to Korean patent application number 10-2015-0085267, filed on Jun. 16, 2015 the entire disclosure of which is incorporated herein in its entirety by reference.

### BACKGROUND

### 1. Field of Invention

The present disclosure relates to a memory management unit and an operating method thereof, and more particularly, to a memory management unit capable of reducing the cost of reclaiming pages from a hierarchical memory that an operating system provides on hardware in a multi-core processor that uses virtual memory.

### 2. Description of Related Art

Generally, a processor has a multilayered memory structure in order to provide a large capacity and a short delay time for approaching data. As illustrated in FIG. 1, the memory hierarchy structure that a processor 10 uses may include an L1 cache 20, an L2 cache 30, an L3 cache 40, a memory 50, and a disk (SWAP area) 60. For example, Intel processors that are widely used in personal computers may include the L1 cache 20 and the L2 cache 30 that are included in processor cores, the L3 cache 40 that exists inside the processors, the memory 50 such as RAMs existing outside the processor, and the disk 60 that provides permanence of data etc. Operations of reading data from the disk 60 or the memory 50 may be controlled by the processor 10 or by system software such as an operating system/virtual machine monitor. In this case, hardware controls from the memory 50 to the caches 20, 30, and 40 that are inside the processor, while the system software controls data transmission from the disk 60 to the memory 50.

In this case, in preparation for memory pressure situations where the memory required by an application program is greater than the memory actually existing in the system, conventional operating systems that support virtual memory provide a SWAP mechanism where a block device such as the disk 60 existing just subordinate to the memory layer is defined as a SWAP area, and a partial area inside the memory 50 is selected as a victim so that data existing in the victim may be copied and evicted to the SWAP area in the subordinate layer, and the area in the memory 50 that used to be the victim is assigned as new memory capacity. An approach to the data copied to the SWAP area is made by selecting a victim in the memory 50 once again, and then copying and evicting the data in the victim to a new SWAP area, and then withdrawing the previously evicted data from the SWAP area. A SWAP device providing such a method is provided at the level of system software, and may therefore perform an application that requires a much greater memory than the memory capacity of the memory 50 installed in the physical system.

Translation lookaside buffer (TLB) is a cache used to increase the speed of converting a virtual memory address into a physical address. TLB is the acronym for the translation lookaside buffer. A general processor for desktops and servers has one or more TLBs in memory management hardware. General hardware that uses virtual memory in page units or in segment units use TLB. The processor 10 first approaches the TLB and searches for a certain page, and if there is no such page in the TLB, the processor 10 refers to a page table of a memory management unit (MMU). FIG. 1 is a view illustrating in detail the functions of the page table and the translation lookaside buffer (TLB) of the memory hierarchical structure mentioned above.

In the processor 10 that uses virtual memory, when an application program approaches a virtual address 110 to read the data stored in the virtual address 110, the processor 10 refers to the translation lookaside buffer 130 to see whether or not there is a mapping to a physical address 170 for the requested virtual address 110 (S101), as illustrated in FIG. 2. The virtual address 110 includes a virtual page number (Virtual Page #) and an offset value, and the physical address 170 includes a physical page number (Physical Page #), and an offset value. The translation lookaside buffer 130 includes a plurality of mapping entries in which mapping information between the virtual page number VPN and the physical page number PPN is recorded. In this case, upon finding a mapping entry from the translation lookaside buffer 130, the processor 10 may approach the physical address 170 based on the information of the mapping entry (S103). The data inside the actual physical memory 190 may be approached in the aforementioned way (S110).

If there is no mapping information about the virtual memory address 110 in the translation lookaside buffer 130, the processor 10 refers to the page table 150 (S105). The page table 150 includes mapping information between the virtual page number and the physical page number, which includes a plurality of page table entries PTE. Upon finding mapping information in reference to the page table 150, the processor 10 approaches the corresponding physical address 170 (S107), and adds the mapping information between the virtual address 110 and the physical address 170 to the translation lookaside buffer 130. On the other hand, if there is no mapping relating to the requested virtual address 110 in the page table 150, the processor 10 generates an exception notifying a page reference failure to the operating system so that a mapping of the subject address may be added. Meanwhile, in a memory pressure situation mentioned above, the operating system selects a page (victim) to reclaim, deletes its mapping information existing in the page table 150, and then requests the processor to delete the corresponding mapping existing in the translation lookaside buffer 130.

A general professor supports a multi-core structure that includes a plurality of cores. In this kind of system, application programs that use a plurality of threads share one page table in order to use one identical address space. Such a page table shared by the application programs brings a TLB entry through the page table as each thread operates in the processor and approaches the memory. As a result, one page table entry will exist in the TLB of a plurality of processor cores as a plurality of copies. FIG. 3 is a view illustrating a method for using the translation lookaside buffer and the page table when approaching virtual memory in a processor that includes a plurality of cores.

Referring to FIG. 3, the processor includes a first core 200 and a second core 201. For convenience sake, illustration of the processor is omitted. The first core 200 and the second core 201 may each refer to a first TLB 210 and a second TLB 211, respectively. Furthermore, the first core 200 and the second core 201 shares one page table 230. The first and the second TLB 210 and 211 illustrated in FIG. 3 include three fields: virtual page number VPN, approach control AC, and physical page number PPN. Herein, detailed illustration on the data in the approach control AC field in the TLB is omitted. Referring to FIG. 3, one can see that the virtual page numbers VPN and the physical page numbers PPN match each other one by one based on the two TLBs 210 and 211 and the page table 230.

FIG. 3 shows that in the processor including a plurality of cores 200 and 201, since two cores 200 and 201 approach a virtual address corresponding to an identical virtual page number 0X0, there is a TLB entry for the address in both TLBs. That is, of the four matching entries included in the first TLB 210, the fourth virtual page number 0x0 also exists in the second TLB 211 as a fourth matching entry. In addition, virtual page number 0x0 exists in the page table as the eighth matching entry. The rest of the six matching entries, that is, virtual page numbers 0x4, 0x2, 0x1, 0x8, 0x6, and 0x5 are each included in only either of the first TLB 210 and the second TLB 211. In this case, in order to delete the TLB matching entry for the virtual page number 0x0 that exists in both TLBs, the TLB entry for the subject address must be deleted from all the cores that may approach the subject address. The processor illustrated in FIG. 3 includes only two cores 200 and 201, but in the case of a processor including four or more cores, if there is a matching entry that numerous TLBs have in common, the number of times of deleting the TLB entry will increase.

Such consistency of TLB is managed by operating systems or system software. For modifying or removing a page table entry, most operating systems use the inter-processor interrupt IPI method. This is a costly method since an IPI for deleting a TLB involves a blocking operation where acknowledgement of an IPI request needs to be checked for every cores before the operations of the processor can be updated. Not only that, an operating system such as LINUX must be synchronized for such modifications of a virtual address space, and thus the operation becomes serialized. This may lead to a problem of reduced throughput when a plurality of threads make an approach to a page evicted from the current main memory.

In such a memory pressure situation, the operating system selects one page as a victim, copies the data in the victim to a layer subordinate to the memory, deletes the mapping for the victim from the page tables, and finally, uses IPI to delete any TLN entry that may potentially exist in every core. However, conventional page reclaiming methods and policies are merely based on orders of the requests made, filtering recent page approaches and the like, and thus the reclaiming cost for a multi-core computer structure is much higher than that of a single core computer structure, which is a problem.

### SUMMARY

Therefore, embodiments of the present disclosure provides a memory management unit capable of reducing page reclaiming costs and an operating method thereof.

According to an embodiment of the present disclosure, there is provided a memory management unit MMU for managing virtual memory for a plurality of cores, the unit including translation lookaside buffers TLBs each corresponding to each of the cores; a plurality of page tables each corresponding to each of the cores and to each of the TLBs, and synchronized with the corresponding TLB, one of the plurality of page tables being a main page table; a meta page including virtual page-physical page mapping information included in the plurality of page tables, wherein the meta page includes a shared bit field indicating whether or not the virtual page-physical page mapping information is stored in the plurality of TLBs.

In the embodiment, the plurality of page tables may each include an entry validity field indicating whether or not each entry is valid, and when one of the plurality of cores tries to approach a new virtual page, if a page table corresponding to the one core is the main page table, the virtual page-physical page mapping information may be registered in the entry of the page table corresponding to the one core, and a bit of the entry validity field corresponding to the entry may be updated to a valid bit.

In the embodiment, when the one of the plurality of cores tries to approach a new virtual page, if the page table corresponding to the one core is not the main page table, the virtual page-physical page mapping information may be registered in entries of the page table corresponding to the one core and in entries of the main page table, and a bit of the entry validity field corresponding to an entry of the virtual page-physical page mapping information registered in the page table corresponding to the one core may be updated to a valid bit.

In the embodiment, when one of the plurality of cores tries to approach a virtual already registered in the meta page, a shared field bit of an entry of the virtual page registered in the meta page may be updated.

According to another embodiment of the present disclosure, there is provided a method for operating a memory management unit MMU for managing virtual memory for a plurality of cores, the method including receiving a request to approach a virtual memory number made by one of the plurality of cores, determining whether or not a page table of the core that requested to approach the virtual memory number is a main page table; updating the page table depending on whether or not the page table is the main page table; and updating a meta page based on the updating of the page table.

In the embodiment, the updating the page table depending on whether or not the page table is the main page table may include, when the page table of the core that requested to approach the virtual memory number is the main page table, updating a virtual page number-physical page number entry of the page table.

In the embodiment, the updating the page table depending on whether or not the page table is the main page table may include, when the page table of the core that requested to approach the virtual memory number is not the main page table, updating the virtual page number-physical page number entry of the page table; and updating the virtual page number-physical page number entry of the main page table.

In the embodiment, the updating the meta page based on the updating of the page table may include updating an approach core bit field of an entry corresponding to the virtual page number; and updating a shared bit field depending on whether or not a plurality of cores approached the virtual page number.

According to another embodiment of the present disclosure, there is provided a method for operating a memory management unit MMU for managing virtual memory for a plurality of cores, the method including receiving a request to reclaim a page; electing a victim page from an LRU list in a current core based on the request to reclaim a page; determining whether or not the page is a shared page; deleting an entry of a page table corresponding to the victim page based on a result of the determining whether or not the page is a shared page; and invalidating a TLB corresponding to the entry of the page table.

In the embodiment, the method may further include, when the page is a shared page: updating a meta page based on the deleted entry of the page table; and searching for the victim page in the LRU list of another core, after the invalidating a TLB corresponding to the entry of the page table.

The memory management unit and the operating method thereof according to an embodiment of the present disclosure may significantly reduce the memory reclaiming costs in a multi-core processor. Therefore, it is possible to place a memory device that supports a low delay high bandwidth such as a non-volatile memory NVM express or a remote memory in a lower layer, and reduce the memory pressure caused by insufficient memory in the system when using the memory device as a SWAP device. By doing this, it is possible to reduce performance deterioration caused by using the SWAP device without having to modify the applications in an in-memory database, an in-memory parallel workload, or in a system that requires a large amount of memory for dielectric analysis, for example.

### BRIEF DESCRIPTION OF THE DRAWINGS

The above and other features and advantages of the present disclosure will become more apparent to those of ordinary skill in the art by describing in detail embodiments with reference to the attached drawings in which:

FIG. 1 is a view illustrating a layer structure of a general memory;

FIG. 2 is a view illustrating functions of a page table and a translation lookaside buffer in the layer structure of the memory;

FIG. 3 is a view illustrating a method for using the translation lookaside buffer and the page table when approaching virtual memory in a processor that includes a plurality of cores;

FIG. 4 is a view illustrating a method for applying the page table to every core when approaching the virtual memory in the processor that includes a plurality of cores according to an embodiment of the present disclosure;

FIG. 5 is a view illustrating frame page assignment when one core tries to approach the virtual memory according to the embodiment of the present disclosure;

FIG. 6 is a view illustrating a method for applying the page table to every core, and synchronizing the page table and the translation lookaside buffer through a meta page according to the embodiment of the present disclosure;

FIG. 7 is a view illustrating a method for updating the meta page and the page table when one core corresponding to a main page table tries to approach the virtual memory in the embodiment of FIG. 6;

FIG. 8 is a view illustrating a method for updating the meta page and the page table when one core not corresponding to the main page table tries to approach the virtual memory in the embodiment of FIG. 6;

FIG. 9 is a view illustrating a method for updating the meta page and the page table when one core not corresponding to the main page table tries to approach the virtual memory in the embodiment of FIG. 8; and

FIG. 10 is a view illustrating a process of reclaiming a page in a method for operating a memory management unit according to the embodiment of the present disclosure.

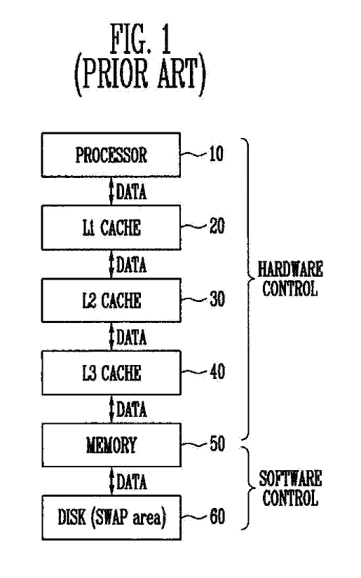

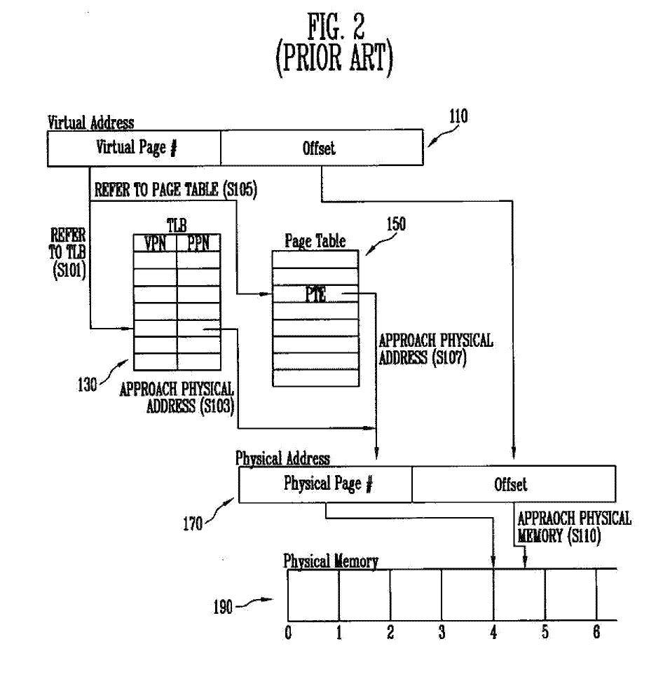

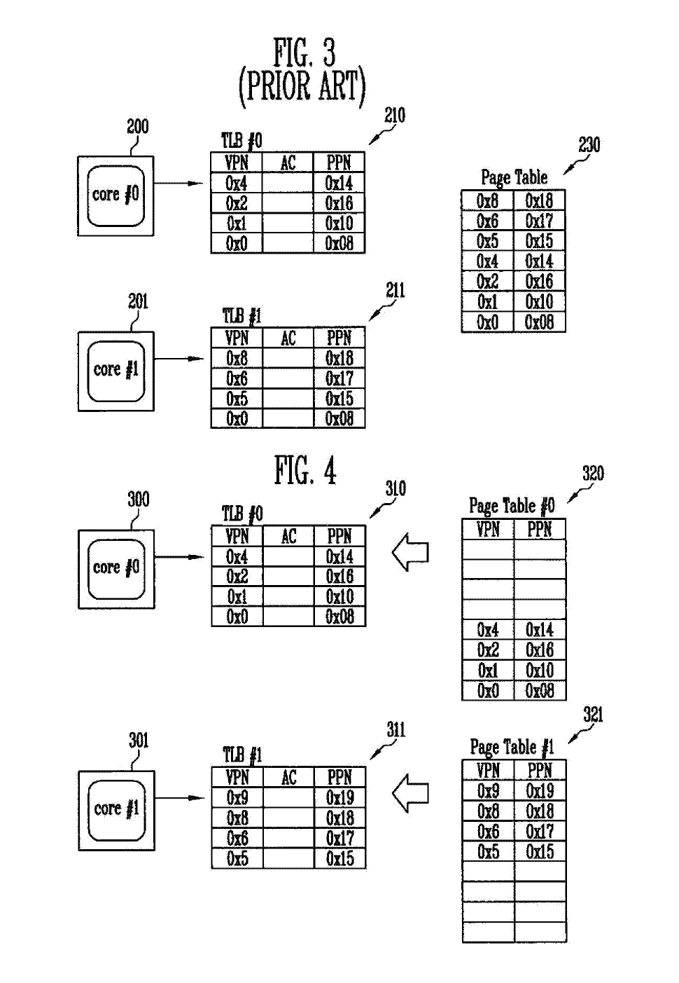

### DETAILED DESCRIPTION

Hereinafter, embodiments will be described in greater detail with reference to the accompanying drawings. Embodiments are described herein with reference to cross-sectional illustrates that are schematic illustrations of embodiments (and intermediate structures). As such, variations from the shapes of the illustrations as a result, for example, of manufacturing techniques and/or tolerances, are to be predicted. Thus, embodiments should not be construed as limited to the particular shapes of regions illustrated herein but may include deviations in shapes that result, for example, from manufacturing. Like reference numerals in the drawings denote like elements. Furthermore, ‘connected’ represents that one component is directly connected to another component or indirectly connected through another component. In this specification, a singular form may include a plural form as long as it is not specifically mentioned. Furthermore, ‘include/comprise’ or ‘including/comprising’ used in the specification represents that one or more components, steps, operations, and elements exist or are added. Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

In a computer with a multi-core structure, IPI-dependent TLB invalidation method accounts for most of the costs for reclaiming a page. This leads to deterioration of throughput for both sides of a transmitter and a receiver of IPI in the system. For the transmitter, a delay time occurs in receiving acknowledgement of all processor cores as mentioned above, and for the receiver, the throughput decreases as IPI has to be received repeatedly due to having to stop the flow of a currently operating core, and switch to an interrupt context to process a TLB shootdown. When using the management unit and the operating method thereof according to the present disclosure, it is possible to reclaim pages without depending on IPI.

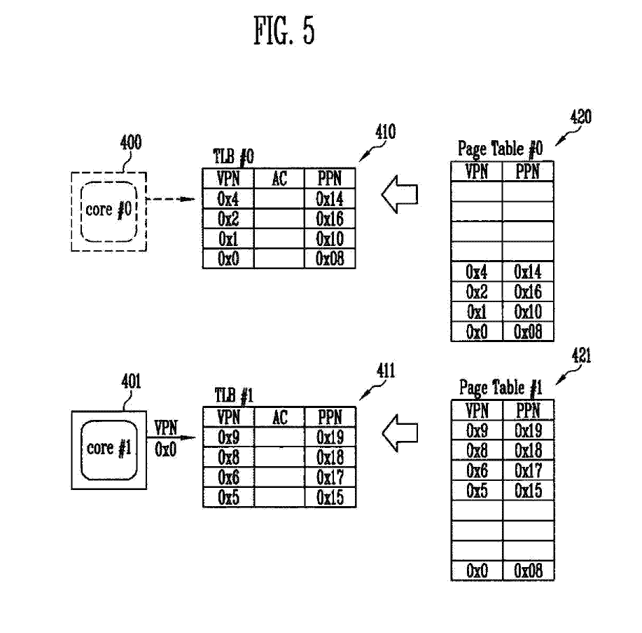

FIG. 4 is a view illustrating a method for applying a page table to every core when approaching virtual memory in a processor that includes a plurality of cores according to an embodiment of the present disclosure.

The memory management unit according to the present disclosure manages the virtual memory for the plurality of cores. The memory management unit includes a plurality of translation lookaside buffers TLBs corresponding to each of the cores; a plurality of page tables corresponding to each of the cores and to each of the TLBs, and synchronized to a corresponding TLB; and a meta page that includes virtual page-physical page mapping information included in the plurality of page tables. One of the plurality of page tables is a main page table. Unlike in the conventional address space management method where threads share one page table, in the present disclosure, a multi-page table is used where, to one address space, page tables are assigned by as many as the number of the cores in the processor, and when a request for memory is made by a core, a mapping between a subject virtual address and a physical address is entered into a page table to be used exclusively for each core.

FIG. 4 illustrates an approach to virtual memory in a processor that includes two cores 300 and 301. Upon a request to approach the virtual memory, the first core 310 approaches a first TLB 310. If the first TLB 310 does not have a corresponding virtual page-physical page mapping information, the first core 310 then refers to a first page table 320. Furthermore, the second core 301 approaches a second TLB 311 first, and if the second TLB 311 does not have a corresponding virtual page-physical page mapping information, the second core 301 refers to a second page table 321. That is, unlike the conventional methods, in the present disclosure, each core 310 and 311 has and uses its own page table 320 and 321. FIG. 4 illustrates a case where the first core 300 requested memory for virtual page numbers 0x0, 0x1, 0x2, and 0x4, and the second core 301 requested memory for virtual page numbers 0x5, 0x6, 0x8, and 0x9. In this case, a page fault processor performs a virtual page number-physical page number mapping for each memory request made by the first core 300 in the page table 320 that the first core 300 has, and performs a virtual page number-physical page number mapping for each memory request made by the second core 301 in the page table 321 that the second core 301 has.

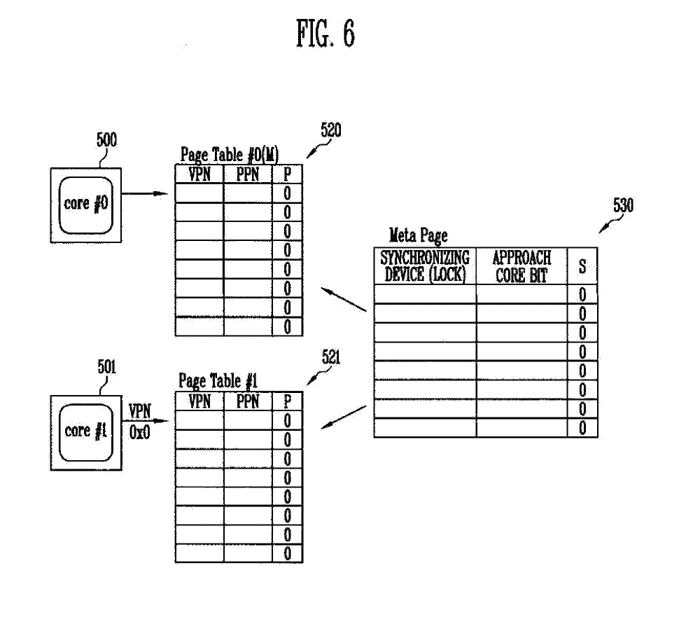

FIG. 5 is a view illustrating frame page assignment when one core tries to approach the virtual memory according to the embodiment of the present disclosure. Specifically, FIG. 5 illustrates a situation where a request to approach the virtual memory is made following the situation in FIG. 4. Referring to FIG. 5, there is a first core 400, a first TLB 410 and a first page table 420 corresponding to the first core 400, a second core 410, and a second TLB 411 and a second page table 421 corresponding to the second core 410. FIG. 5 illustrates identical page frame assignment being made when the second core CPU1 approaches virtual page number “0x0”. For such an approach to an identical virtual address, synchronization is required. That is, for an identical virtual page number VPN-physical page number PPN, the first page table 420 and the second page table 421 need not be the same, but they need to be synchronized with each other.

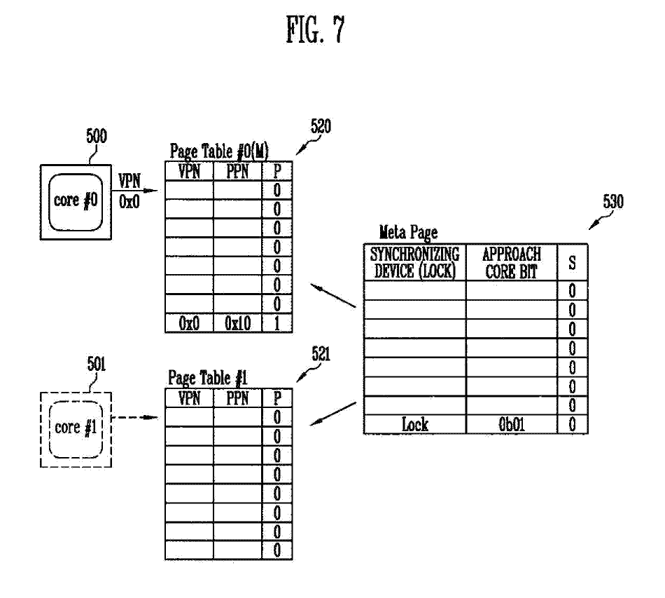

FIG. 6 is a view illustrating a method for applying a page table to each core, and synchronizing a page table and a translation lookaside buffer through a meta page. In FIG. 6, the memory management unit according to the embodiment of the present disclosure includes a first page table 520, a second page table 521, and a meta page 530 for processing an approach to the virtual memory made by a first core 500 and a second core 501. Although not illustrated in FIG. 6, the memory management unit according to the embodiment of the present disclosure includes a first TLB and a second TLB for the first core 500 and the second core 501. The first TLB and the second TLB are omitted from FIG. 6 for convenience sake. In FIG. 6, the first page table 520 is a main page table, but the second page table 521 is not a main page table.

The meta page 530 may be used to synchronize the first page table 520 and the second page table 521 effectively and to reduce the page reclaiming costs. That is, since a plurality of page tables 520 and 521 are in use for a plurality of threads, it is necessary to synchronize the page tables 520 and 521, and thus a meta page 530 is used for the synchronization in each process. In the memory management unit and the operating method according to the embodiment of the present disclosure, the meta page 530 has three fields: a synchronizing device LOCK field, an approach core bit field, and a share bit field S. The synchronizing device LOCK field is a field for changing an entry of the meta page, the approach core bit field is a field for indicating which core approached the virtual page-physical page mapping. The share bit field S is a field for indicating whether a single core approached the virtual page-physical mapping or a plurality of cores approached the virtual page-physical mapping.

In the field data of the approach core bit of the meta page 530, whether or not a request was made for a virtual page for a certain virtual page number (VPN), and how many cores approached the page since then may be recorded. This enables parallel applications to differentiate between a case where one core approached a virtual page using a plurality of threads and a case where only one core approached the page. This means that at any point, mapping sets existing in the page tables assigned to each core may be supersets of TLB entries.

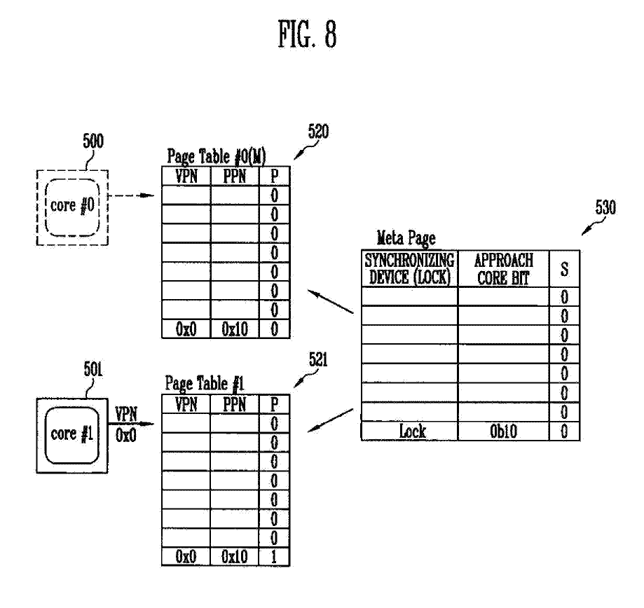

Hereinafter, explanation will be made on a method for updating the page tables 520 and 521 and the meta page 530 as an approach is made to a virtual memory address by the cores 500 and 501 with reference to FIGS. 7 to 9.

FIG. 7 is view illustrating a method for updating the meta page and the page tables in the case where one core corresponding to the main page table approaches the virtual memory.

In the memory management unit and the operating method thereof according to the embodiment of the present disclosure, multi-threads belonging to one process have page tables as many as the number of cores that can be scheduled. In FIG. 7, the page table 520 corresponding to the first core 500 is designated as the main page table as an example. However, the other page table 521 is not a main page table. FIG. 7 illustrates the main page table 520 and the general page table 521 when there are two cores, but there is no limitation thereto. There may be more cores, but even so, each core will have a page table, and one of them will be the main page table.

The main page table 520 is used to store a mapping relationship when a core 501 other than the core 500 corresponding to the subject page table 520 requests to approach the page. FIG. 7 illustrates a state of the page tables 520 and 521 and the meta page 530 when the first core 500 approaches virtual page number VPN “0x0”. In this case, its matching virtual page-physical page mapping needs to be loaded in the TLB corresponding to the first core 500, and thus a corresponding mapping is installed in the page table 520, and P bit for indicating that the installed entry is valid is set to 1. Furthermore, the approach core bit of the meta page 530 will include information that the first core 500 has approached. That is, in the example in FIG. 7, “0b01” is recorded in the approach processor bit field of the meta page 530. “0b01” indicates that bit number 0 of the approach core bit is “1”, meaning that the first core 500 approached virtual page number 0x0. Furthermore, since the share bit field S is maintained at “0”, it means that only one core approached to that particular virtual page number.

In FIG. 7, the core that approached the page address is the first core 500, and the page table 520 corresponding to the first core 500 is the main page table. According to the present disclosure, a page table is provided for every core for approaches to be made to the virtual memory in a multi-core processor environment, and one of the page tables is designated to function as a main page table that operates differently from other page tables. That is, in the memory management unit of the present disclosure, updating the page table is performed differently depending on whether it is the core corresponding to the main page table that approached the virtual memory or it is a core corresponding to a page table other than the main page table that approached the virtual memory. Hereinafter, explanation will be made on how a page table is updated when a core corresponding to a page table other than the main page table approaches the virtual memory with reference to FIG. 8.

FIG. 8 is a view illustrating a method for updating the meta page and the page tables in the case where a core that does not correspond to the main page table approaches to the virtual memory in the embodiment of FIG. 6.

FIG. 8 is not an illustration of the second core 501 approaching virtual page number “0x0” subsequently to the situation illustrated in FIG. 7. FIG. 8 is an illustration of the second core 501 approaching virtual page number “0x0” with the page tables 520 and 521 having been initialized. In other words, FIG. 8 illustrates the second core 501 approaching virtual page number “0x0” where the first core 500 has not approached the virtual page number “0x0”, unlike in the FIG. 7.

Referring to FIG. 8, the first core 500 has not approached virtual page number “0x0”. However, the second core 501 approached virtual page number “0x0”, and thus an entry of the page table 521 corresponding to the second core 501 may be updated. Furthermore, along with the updating of the page table 521 corresponding to the second core 501, the page table 520 corresponding to the first core 500 may also be updated.

In FIG. 7, the page table 520 corresponding to the core 500 that approached virtual page number “0x0” was a main page table and thus only the main page table was updated, and the other page tables were not. However, since the page table 521 corresponding to the core 501 that approached virtual page number “0x0” is not a main page table, the main page table 520 is also updated along with the page table 521. However, the P field of the entry where virtual page number “0x0” is recorded in the main page table 520 is maintained at “0”, from which one can know that virtual page number “0x0” was approached by not the first core 500 but another core. Furthermore, the P field of the entry where virtual page number “0x0” is recorded in the page table 521 corresponding to the first core is changed to “1”, from which one can know that virtual page number “0x0” was approached by the second core 501 that corresponds to that page table.

FIG. 8 also illustrates a state of the meta page 530 in the case where the second core 501 approached virtual page number VPN “0x0”. Unlike FIG. 7, “0b10” is recorded in the approach processor bit field of the meta page 530. “0b10” indicates that bit number 1 of the approach core bit is “1”, meaning that the second core 501 approached virtual page number “0x0”. Furthermore, the share bit field S is maintained at “0”, meaning that only one core approached that virtual page number just as in FIG. 7.

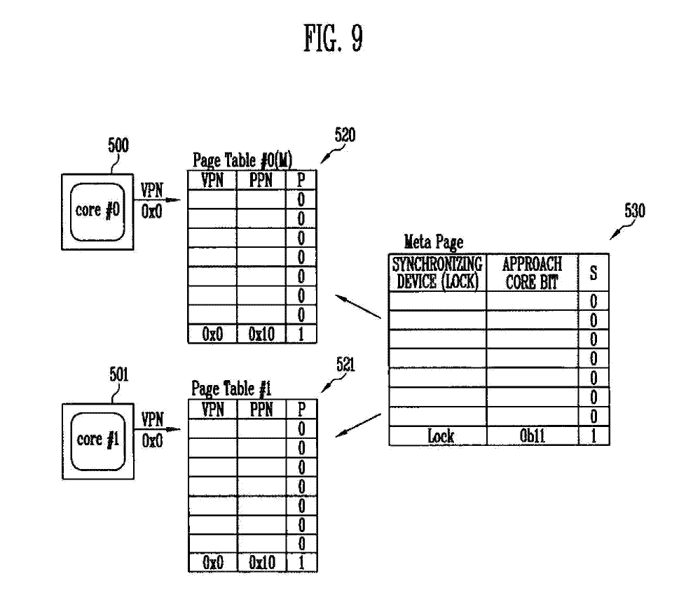

FIG. 9 is a view illustrating a method for updating the meta page and the page tables in the case where another core that corresponds to the main page table approaches the virtual memory. That is, FIG. 9 illustrates the case of updating the page tables 520 and 521 and the meta page when the first core 500 also approaches the same virtual page number “0x0” after the second core 501 approaches virtual page number “0x0” as explained with reference to FIG. 8.

When the first core 500 approaches virtual page number “0x0” after the second core 501 approaches virtual page number “0x0”, since the page table 520 corresponding to the first core 500 is the main page table, only the main page table is updated, but the other page table 521 is not updated. Referring to FIG. 8 and FIG. 9, since there already is an entry for virtual page number “0x0” of the first page table 520, it is possible to approach the physical page number through the entry of that virtual page number. Furthermore, since the first core 501 approached virtual page number with the P bit of the first page table being “0”, the P bit of the entry of virtual page number “0x0” is changed to “1”. From this change of bit, one can know that virtual page number “0x0” stored in the main page table 520 was approached by the corresponding first core 501.

Furthermore, when the core 501 approaches virtual page number “0x0”, the metal page 530 is also updated. The synchronizing LOCK field is maintained, but the approach core bit field is changed from “0b10” to “0b11”. Since the 0^{th} and the 1^{st} bit of the approach core bit field are both 1, one can know that virtual page number “0x0” was approached by both the first core 500 and the second core 501. Furthermore, since the share bit field S is changed from 0 to 1, one can know that a plurality of cores 500 and 501 approached virtual page number “0x0”. This shows that TLB entry invalidation instruction needs to be performed by numerous processors after checking the shared bit fields, in the case of subsequently reclaiming virtual page number “0x0”. Using this page structure, it is possible to identify in which core of the system the mapping between a virtual page number and a physical page number exists, and perform a TLB invalidation instruction only to that core, thereby reducing aggressive use of IPI in TLB invalidation.

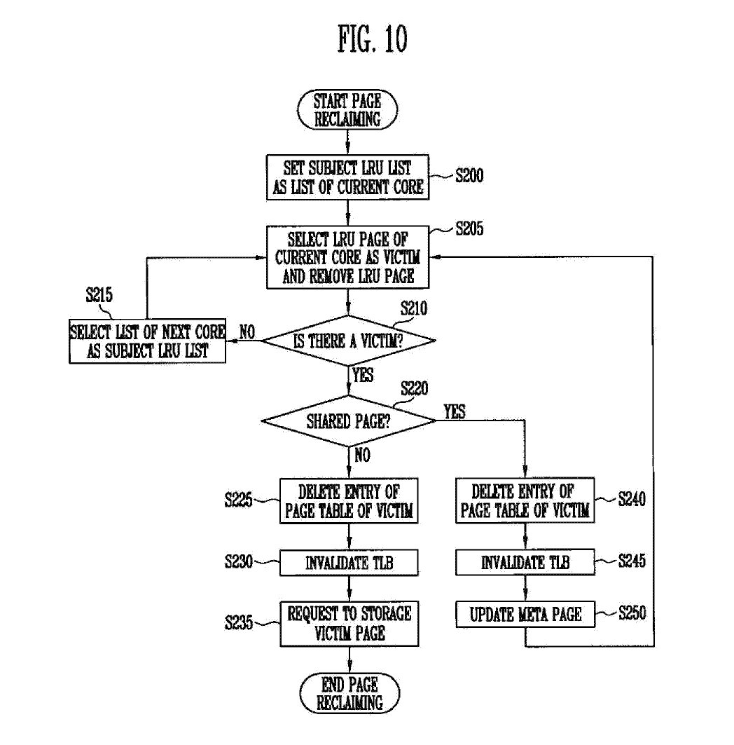

FIG. 10 is a view illustrating a page reclaiming process of the method for operating the memory management unit according to the embodiment of the present disclosure.

Conventional page reclaiming policies involve identifying approaches made to pages starting from LRU pages, and selecting a page (victim) to reclaim. This method involves selecting a least recently used LRU page in using the cache effect of the main memory for a lower memory layer. However, maintaining a complete LRU list regarding memory approaches is extremely complicated at the software level, thereby consuming much resources of the system, which is a problem. Therefore, it is necessary to use a method that could substitute the method of maintaining a complete LRU list of memory approaches. The memory management unit and the operating method thereof according to the present disclosure additionally take into account how many processors approached a page when selecting the page to reclaim. FIG. 10 is a flowchart illustrating the memory management unit and the operating method thereof according to embodiment of the present disclosure. The method illustrated in FIG. 10 utilizes the page structure and the operating method explained with reference to FIGS. 4 to 9 in tracking approaches to virtual page numbers made by each core.

When there is insufficient memory, pages to be reclaimed are limited to the pages within a current core, which is the same as in conventional methods. That is, an LRU list is selected such that it includes pages existing in the page tables of the current core, not based on the existing page tables shared by all the cores (S200). Of the pages approached by the current core, an LRU page is selected as the victim (S205) as in the conventional methods, and then whether or not a victim exists is identified (S210). Whether or not the subject page is a virtual page being shared by the current plurality of cores is identified based on the shared bit field in the meta page (S220). If the page is a page that is not being shared, this means that the virtual page number-physical page number mapping does not exist in the TLB of other cores. Therefore, the mapping entry of the page table is deleted for the current processor only (S225), and TLB invalidation instruction is performed (S230). Then for the victim for which unmapping has been completed, a request is made to store the victim in a lower memory (S235).

If the victim selected at step S205 is a shared page, this may mean that the victim is a page approached by a plurality of processors, and thus has a greater significance compared to other pages. In order to maintain such significance of the virtual page number-physical page number mapping, the operating method of the memory management unit according to the embodiment of the present disclosure checks the shared bit field of the meta page, and if it is a shared page, the mapping entry in the page table of its core is deleted (S240), and the TLB is invalidated (S245). Then, the meta page is updated (S250). In this case, the meta page may be updated by deleting from the approach core bit the serial number of the core for which the TLB was invalidated just previously. For example, in the case where the mapping entry in the page table 521 for the first core 501 has been deleted at a situation of FIG. 9, the approach core bit of the meta page 530 may be changed from “0b11” to “0b01”.

After deleting the mapping entry in the page table corresponding to the subject core (S240), invalidating the TLB corresponding to that core (S245), and updating the meta page (S250), a victim may be searched from the LRU list again (S210). In this case, if a victim cannot be found from the subject LRU list, this means that the current LRU list is empty. Therefore, an LRU list of the next core may become the subject LRU list (S215), and the aforementioned process may be performed again.

In the aforementioned memory management unit and the operating method thereof according to the embodiment of the present disclosure, since a page table is designated for each core, and a meta page is designated as well, it is possible to significantly reduce the memory reclaiming costs in a processor that includes a plurality of cores. Therefore, it is possible to reduce memory pressure caused by insufficiency of memory in the system in the case of placing a memory device that supports a short delay time high bandwidth such as a non-volatile memory NVM express and a remote memory in a lower layer of a current memory to use the memory device as an SWAP device. By doing this, it is possible to reduce performance deterioration caused by using the SWAP device without having to modify the applications in an in-memory database, an in-memory parallel workload, or in a system that requires a large amount of memory for dielectric analysis, for example.

Herein, it should be understood that each block in the process flowcharts and combinations thereof may be performed by computer program instructions. These computer program instructions may be mounted onto a processor of a general use computer, a special use computer, and other programmable data processing equipment, and thus means for performing the functions explained in the flowchart block(s) may also be provided. These computer program instructions may use a computer, or a computer oriented towards other types of programmable data processing equipment, or may be stored in a computer readable memory, and thus instructions may be produced as manufactured products that contain means to perform the functions explained in the flowchart block(s). Since the computer program instructions may be mounted onto a computer or other programmable data processing equipment, the aforementioned series of steps may be performed in such a computer or other programmable data processing equipment to be implemented in a computer, and thus the instructions may be also provided as steps for implementing the functions explained in the flowchart block(s).

In the memory management unit and the operating method thereof according to the present disclosure, a page table corresponding to each core may exist inside the core or inside a processor outside the core. Otherwise, the page tables and a meta page may exist in a memory device inside the memory management unit. The page tables and the meta page may be configured as separate memory spaces, or an address space dynamically assigned in a single memory device.

Furthermore, each block may represent a portion of a module, a segment, or a code that includes one or more executable instructions for executing certain logical function(s). Furthermore, it should be noted that in some alternative embodiments, the functions mentioned in the blocks may take place in an order different from those aforementioned. For example, any two blocks illustrated successively may actually be performed at the same time, or performed in reversed orders depending on the functions.

Herein, the term ‘˜unit’ refers to software or a hardware component such as an FPGA, ASIC and the like, and thus ‘˜unit’ may perform the functions of such software or hardware components. However, ‘˜unit’ is not limited to software or hardware. ‘˜unit’ may be configured to exist in an addressable storage medium, or configured to execute one or more processors. Therefore, examples of ‘˜unit’ include components such as software components, object-oriented software components, class components and task components, processes, functions, procedures, subroutines, segments of program codes, drivers, firmware, micro-codes, circuits, data, database, data structures, tables, arrays, and parameters. The components and the functions provided in the ‘˜units’ may be combined into a smaller number of components and ‘˜units’, or be further divided into additional components and ‘˜units’. Not only that, the components and the ‘˜units’ may be realized to execute one or more CPUs in a device or a security multimedia card.

In the drawings and specification, there have been disclosed typical exemplary embodiments of the invention, and although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

What is claimed is:

1. A memory management unit MMU for managing virtual memory for a plurality of cores, the unit comprising:
a plurality of translation lookaside buffers TLBs each corresponding to each of the plurality of cores;
a plurality of page tables each corresponding to each of the cores and to each of the TLBs, and synchronized with the corresponding TLB, one of the plurality of page tables being a main page table;
a meta page comprising virtual page-physical page mapping information included in the plurality of page tables,
wherein the meta page comprises a shared bit field indicating whether or not the virtual page-physical page mapping information is stored in the plurality of TLBs.

2. The unit according to claim 1,
wherein the plurality of page tables each comprise an entry validity field indicating whether or not each entry is valid, and
when one of the plurality of cores tries to approach a new virtual page,
if a page table corresponding to the one core is the main page table, the virtual page-physical page mapping information is registered in the entry of the page table corresponding to the one core, and a bit of the entry validity field corresponding to the entry is updated to a valid bit.

3. The unit according to claim 2,
when the one of the plurality of cores tries to approach a new virtual page,
if the page table corresponding to the one core is not the main page table, the virtual page-physical page mapping information is registered in entries of the page table corresponding to the one core and in entries of the main page table, and a bit of the entry validity field corresponding to an entry of the virtual page-physical page mapping information registered in the page table corresponding to the one core is updated to a valid bit.

4. The unit according to claim 3,
when one of the plurality of cores tries to approach a virtual already registered in the meta page, a shared field bit of an entry of the virtual page registered in the meta page is updated.

5. A method for operating a memory management unit MMU for managing virtual memory for a plurality of cores, the method comprising:
receiving a request to approach a virtual memory number made by one of the plurality of cores;
determining whether or not a page table of the core that requested to approach the virtual memory number is a main page table;
updating the page table depending on whether or not the page table is the main page table; and
updating a meta page based on the updating of the page table.

6. The method according to claim 5,
wherein the updating the page table depending on whether or not the page table is the main page table comprises, when the page table of the core that requested to approach the virtual memory number is the main page table, updating a virtual page number-physical page number entry of the page table.

7. The method according to claim 5,
wherein the updating the page table depending on whether or not the page table is the main page table comprises, when the page table of the core that requested to approach the virtual memory number is not the main page table, updating the virtual page number-physical page number entry of the page table; and
updating the virtual page number-physical page number entry of the main page table.

8. The method according to claim 5,
wherein the updating the meta page based on the updating of the page table comprises:
updating an approach core bit field of an entry corresponding to the virtual page number; and
updating a shared bit field depending on whether or not a plurality of cores approached the virtual page number.

9. A method for operating a memory management unit MMU for managing virtual memory for a plurality of cores, the method comprising:
receiving a request to reclaim a page;
selecting a victim page from an LRU list in a current core based on the request to reclaim a page;
determining whether or not the page is a shared page,
deleting an entry of a page table corresponding to the victim page based on a result of the determining whether or not the page is a shared page; and
invalidating a TLB corresponding to the entry of the page table.

10. The method according to claim 9,
further comprising, when the page is a shared page:
updating a meta page based on the deleted entry of the page table; and
searching for the victim page in the LRU list of another core, after the invalidating a TLB corresponding to the entry of the page table.
